(19) United States
(12) Patent Application Publication
(10) Pub. No.: US 2013/0015674 A1
(43) Pub. Date: Jan. 17, 2013

(54) Door Latch Assembly

(71) Applicant: Wenlie He, Zhongshan (CN)

(72) Inventor: Wenlie He, Zhongshan (CN)

(21) Appl. No.: 13/536,623

(22) Filed: Jun. 28, 2012

(30) Foreign Application Priority Data
Jul. 15, 2011 (CN) 201120249398.4

(51) Int. Cl. E05B 65/06

(52) U.S. Cl. 292/336.3

(57) ABSTRACT

A door latch assembly for use with a pocket door or sliding door has a pull plate surround a latch tong, a up-and-down catch piece set inside the latch tong and coordinate with other elements like a sleeve, a wall plate, a extending tip and a arm connector to accomplish three actions: the pull plate extended out for certain distance when pressed, and the door can be pulled forward; turn the rotary knob to stretch the latch tong and up-and-down catch piece out and lock inside the opening of the strike, and the door is locked; turn the rotary knob reversely to draw back the latch tong and up-and-down catch piece from the strike, and the door is unlocked.

### BACKGROUND OF THE INVENTION

The present invention relates to a door latch assembly for use with a pocket door or sliding door, and more particularly, to a door latch assembly having a pull plate.

It is an object of the present invention to provide a novel door latch that requires only one movement to effectively pull the door forward; while the conventional door latch needs two steps, lifting and pulling the door, to achieve that.

It is a further object to provide such a door latch wherein a pull plate is more firmly connected to a latch and, therefore, the pull plate is stronger then a similar pulling element that will be found in a conventional door latch

### SUMMARY OF THE INVENTION

The present invention of a door latch assembly consists three main sections: a pull plate, a latch tong and an up-and-down catch piece. Having the pull plate surrounds the latch tong and the up-and-down catch piece seats inside the body of the latch tong, together with other elements of the latch assembly, i.e., a tubular sleeve, arm connector, wall plate, extending tip, clip, cam, and rotary knob, the present door latch assembly can perfectly be applied in three steps: the pull plate will be extruded from sleeve after pull plate is pressed, a door user can pull the door forward; the latch tong will extended out from sleeve when the rotary knob is turned, the up-and-down catch piece springs out upwardly from top of latch tong, both latch tong and up-and-down catch piece then enter and lock inside of a catch hole of a strike plate that is mounted on the other side of the door frame; when the rotary knob is turned reversely, up-and-down catch piece and latch tong retract back into sleeve, then the door can he pushed to open.

The pull plate on its front and both sides, and seats inside the sleeve surrounds the assembled latch tong. A double groove is provided on each flat sides of the cylinder shaped latch tong, an oval shaped horizontal pass-through is located on rear and lower part of the double groove, and a latch hole is located rear and upper part of the double groove. A slideable slot is also set on each flat sides of the cylinder shaped latch tong, on the lower edge of each slideable slot, there is a stop hook for purposes of locking and releasing the pull plate. The latch tong has a stop hook at its very end and the stop hook has a connector hole. A catch cavity is provided on top of latch tong and a pull recess located in the front end of latch tong. In the catch cavity, there arc an up-and-down catch piece having an up-and-down catch spring and a pivot axle to settle the up-and-down catch piece inside the catch cavity.

The pull plate has a pull plate front and two pull plate side with a pivot aperture located on rear part of each pull plate side. There is a knob on the each inner side of the pull plate which engages the switch block. An engagement hook is positioned in the front and lower edge of each pull plate side. After a switch block and a pull plate spring are installed inside of each double groove, push the pull plate into the slidcable slot and attach the pull plate together with latch tong by using a rivet pin. When the pull plate is pushed all the way in, the pull plate front will seat inside the pull recess and flush the front end of latch tong.

Connect an arm connector with the latch tong by inserting a connector plug through the connector hole provided on the stop book. Put a cam and a clip under the arm connector. The cam seats between the round hole of a wall plate and a extending tip. The front end of cam is set inside a swing hole provided at the end of arm connector. Insert flips through slots at the end of the wall plate and the extending tip. When the united wall plate and extending tip inserts into the sleeve, the locking flips on front end of either wall plate or extending tip are inside the rear end of sleeve. Press the intruders provided on the rear end of sleeve to fix and connect the united wall plate and extending tip. At the time, the assembled pull plate and latch tong is already inside the sleeve. Finally, attach a latch front end plate onto the front end of the sleeve to complete the door latch assembly.

When a user's finger presses the pull plate front, the interlocked engagement hook and stop hook is separated. The pull plate is pushed outward by working of the switch block and pull plate spring, and the extruding stops when the latch hole reached the end of horizontal pass-through. When the user pushes the pull plate inward again, the engagement hook and stop hook interlocks and pull plate stays.

When the door latch of present invention is installed inside of a bath door and a user turns a rotary knob located on a escutcheon, the latch tong will extend outward by the pushing force of the arm connector and cam, the up-and-down catch piece will pup out from the catch cavity upwardly by the pushing force of the up-and-down catch spring and the catch nose hooks inside of the slot of the strike plate, and the door is locked. The door can be unlocked when user applies a reverse action of the rotary knob.

### BRIEF DESCRIPTION OF THE DRAWINGS

FIG. 1 is a sectional view of a lock latch assembly embodying the present invention;

FIG. 2 is a left side elevation view of FIG. 1;

FIG. 3 is a right side elevation view of FIG. 1;

FIG. 4 is a bottom plan view of FIG. 1;

FIG. 5 is a top sectional view of FIG. 1;

FIG. 6 is a rear elevation view of the lock latch assembly embodying the present invention;

FIG. 7 is a sectional view of the portion of the latch tong;

FIG. 8 is a left side elevation view of FIG. 7;

FIG. 9 is a bottom plan view of FIG. 7;

FIG. 10 is a top plan view of FIG. 7;

FIG. 11 is a plan view of the portion of the pull plate;

FIG. 12 is a left side elevation view of FIG. 11;

FIG. 13 is a bottom plan view of FIG. 11;

FIG. 14 is a top plan view of FIG. 11;

FIG. 15 pin is a sectional view of the lock latch assembly after the pull plate is pressed;

FIG. 16 is a sectional view of the lock latch assembly with the latch tong extended from the sleeve when the earn is turned to lock position;

FIG. 17 is a perspective view of the lock latch assembly in its original position;

FIG. 18 is a perspective view of the lock latch assembly after the pull plate is pressed;

FIG. 19 is a perspective view of the lock latch assembly with the latch tong extended out when the can is turned to lock position;

FIG. 20 is an exploded view of the lock latch assembly;

FIG. 21 is another perspective view of the lock latch assembly in its original position;

FIG. 22 is another perspective view of the lock latch assembly in its operative position.

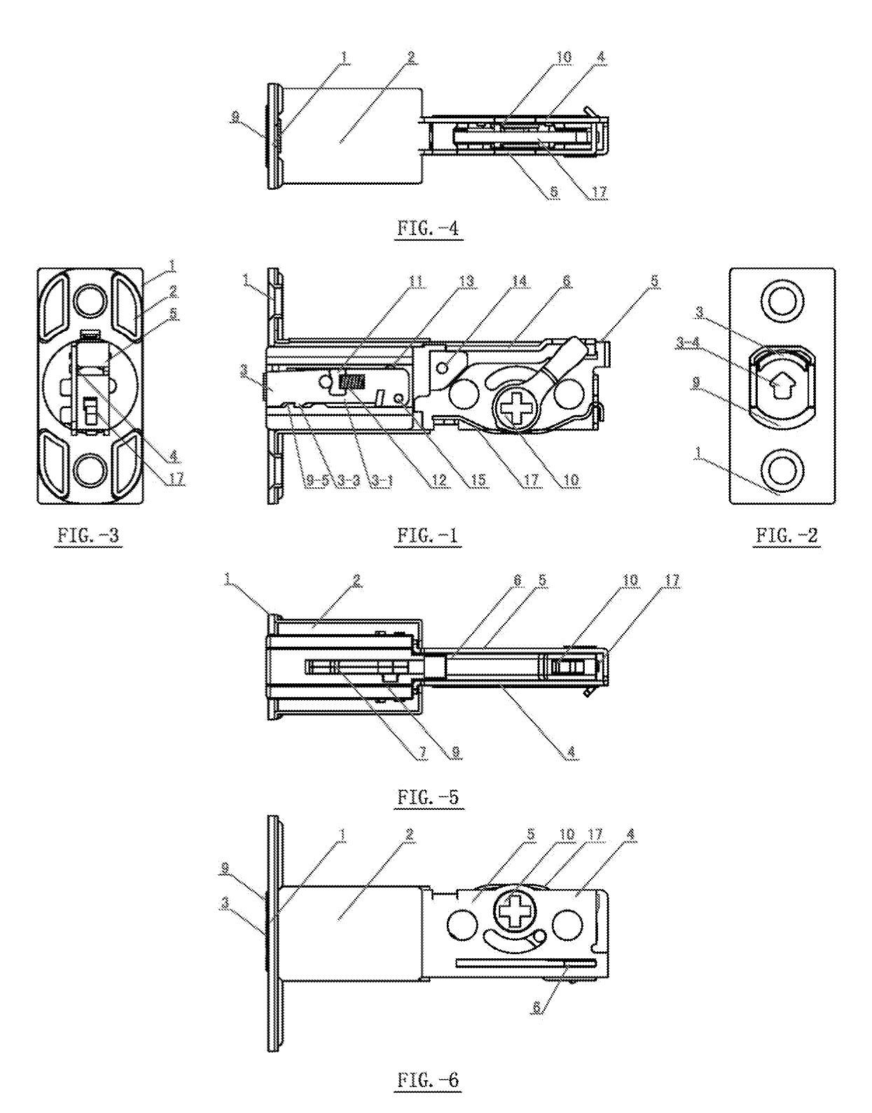

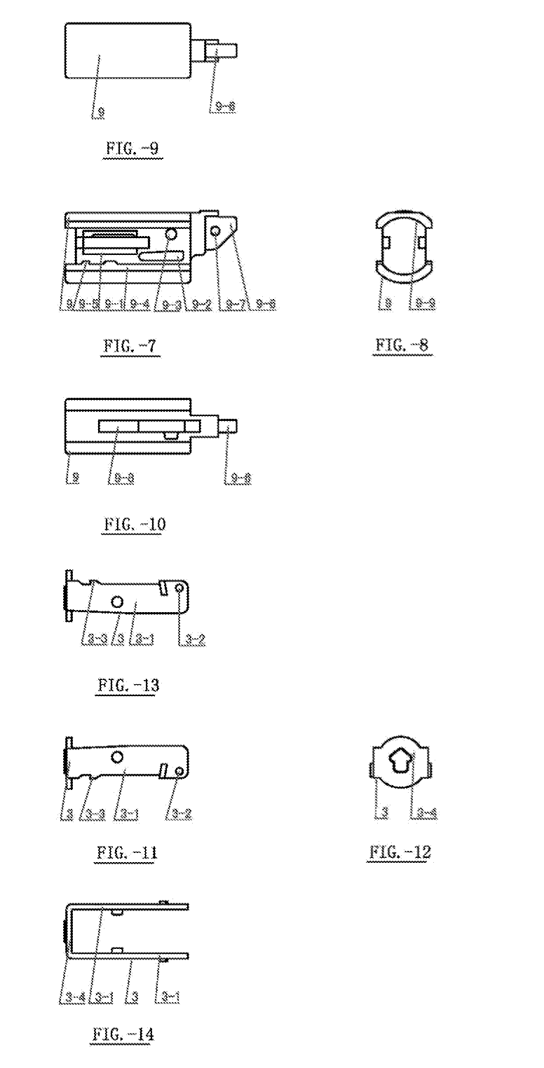

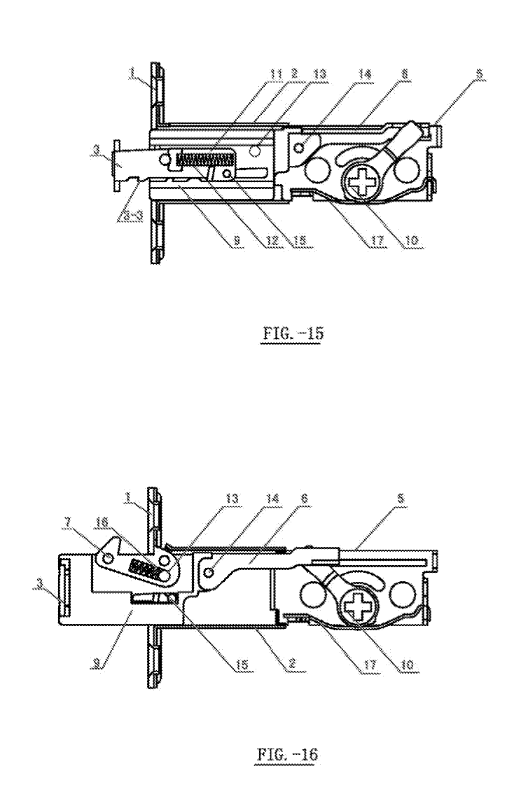

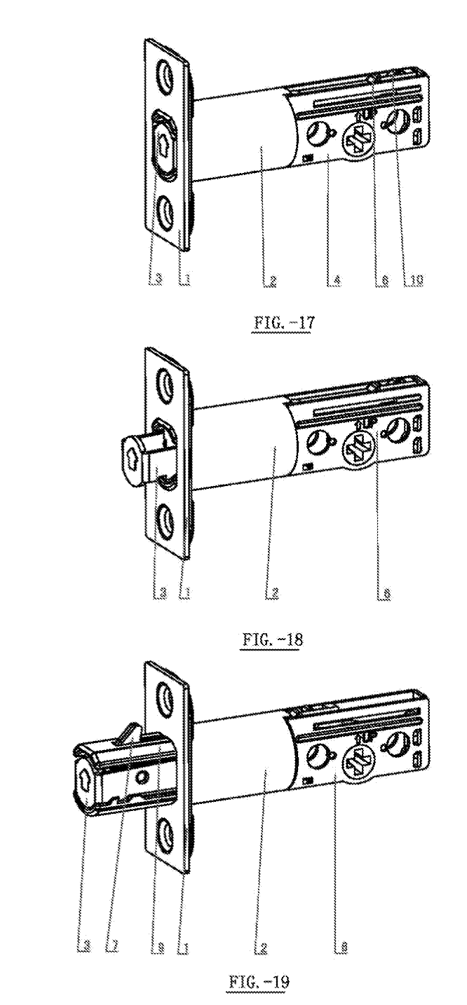

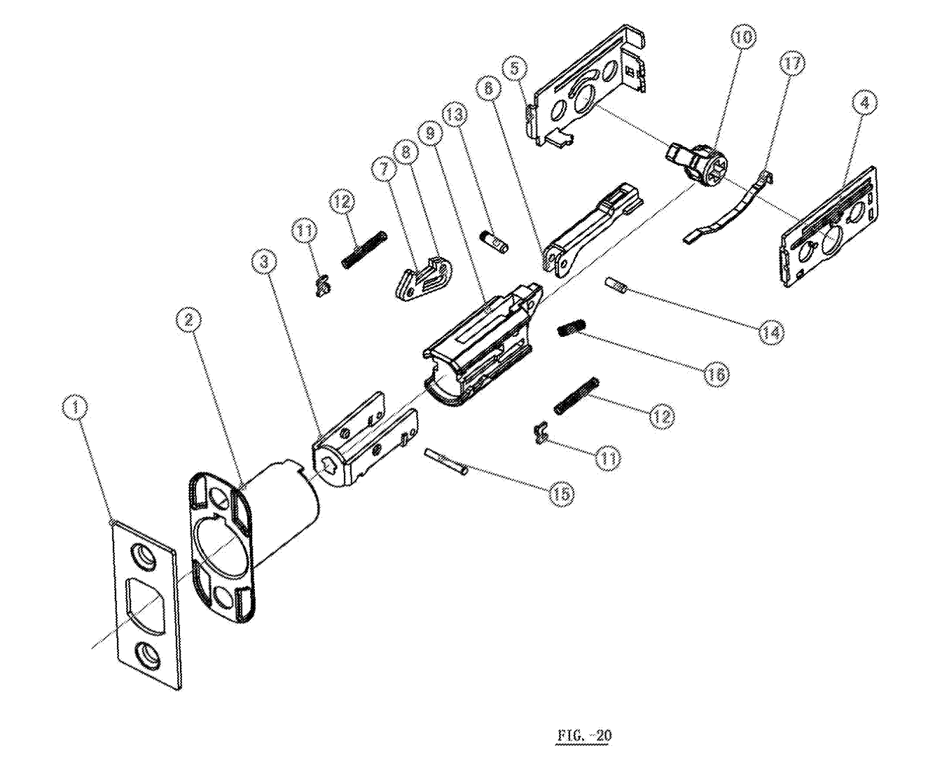

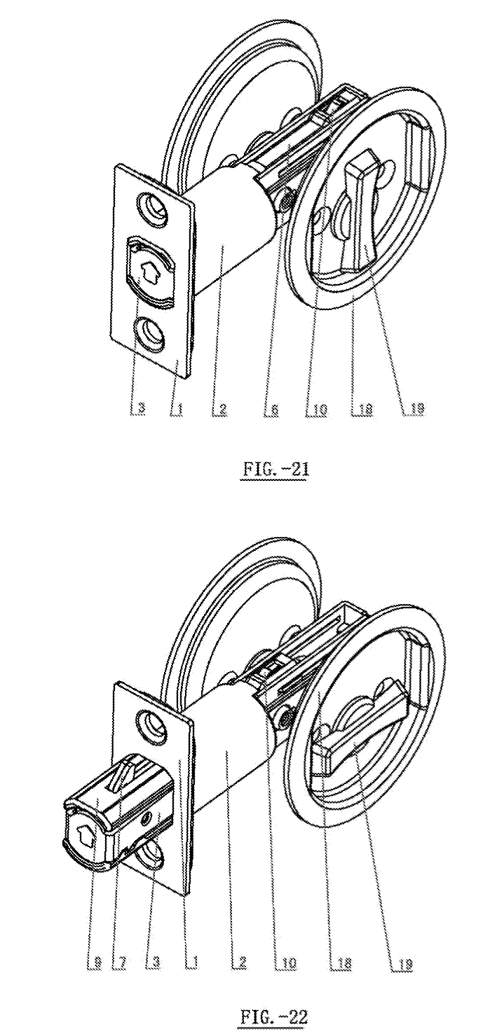

### DETAILED DESCRIPTION OF THE PREFERRED EMBODIMENTS

The present invention is a lock latch assembly having two innovation sections, a pull plate and a latch tong. The preferred embodiment, installation and operation of the present invention can be described in more detail combining with the various drawing figures.

The pull plate 3 has a pull plate front 3-4 and two pull plate sides 3-1 with a pivot aperture 3-2 loaded on rear part of each pull plate side. An engagement hook 3-3 is positioned in the front and lower edge of each pull plate side. The pull plate is within latch tong 9 and is extendable through sleeve 2 and latch front end plate 1.

The latch tong is cylinder shaped having a double groove 9-1 provided on each flat side of the latch tong and an oval shaped horizontal pass-through 9-2 located on rear and lower part of the lip. A latch hole 9-3 is located at the rear and upper part of the double groove. A slideable slot 9-4 is also set over each double groove and on both flat sides of the cylinder shaped latch tong. On the lower edge of each slideable slot, there is a stop hook 9-5. The aforesaid latch tong has a stop hook in its very end and the stop hook has a connector hole 9-7. A catch cavity 9-8 is provided on top of each latch tong and a pull recess 9-9 is located in the front end of latch tong.

The switch block 11 and a pull plate spring 12 are inside the double groove; the up-and-down catch piece 7 is inside the catch cavity while the pull plate spring attaches to the up-and-down catch piece and secures the up-and-down catch piece and the latch tong by applying a pivot axle 13 through the latch hole. The pull plate is in the slideable slot provided on both sides of the latch tong, the pull plate side is connected with the latch tong by a rivet pin 15 passing through the horizontal pass-through, and the pull plate front seats inside the pull recess and flush the front end of the latch tong.

The assembly of a door latch is well known convention skills, which connects a latch tong, arm connector 6, wall plate 4, extending tip 5, clip 17, and cam 10 as a unit. fly putting the specific latch tong and pull plate of the present invention into the sleeve 2, connecting the wall plate and extending tip with the sleeve, and mounting the latch front end plate in front of sleeve, the present invention of a door latch is assembled.

FIG. 21 shows the lock in its original open position; the pull plate is in still when engagement hook and stop hook are interlocked. When user presses the pull plate front, the engagement hook and stop book disengages and by the pushing force of the pull plate spring, the pull plate stretches out for certain distance until the rivet pin reaches the end of horizontal pass-through. The pull plate can then be firmly gripped to pull the door forward. When the door is moved into a position against the latch side of the doorframe, it may be latched and locked by turning the rotary knob 90 degrees. This causes the latch tong moves into the hole provided on the strike and the catch nose 8 engages inside the strike.

What is claimed is:

1. A door latch assembly for use with a pocket door or sliding door comprising:
a pull plate, a latch tong, and an up-and-down catch piece.

2. The door latch assembly of claim 1 where the pull plate comprises a pull plate front and two pull plate sides and where each pull plate side has an engagement hook on the lower edge, a knob on the inner face, and a pivot aperture on the rear part.

3. The door latch assembly of claim 1 where the latch tong is largely cylindrical comprising;
a double groove on each flat side, the double groove further comprising a horizontal pass through at the rear and lower part, a latch hole at the rear and upper part and a slideable slot with a stop hook on the lower edge comprising a connector hole;
a catch cavity on the top; and
a pull recess in the front end.

4. The door latch assembly of claim 1, where the up-and-down piece fits in a catch cavity in the latch tong and comprises a catch nose which can be operably extended from the catch cavity.

5. door latch assembly of claim 1;
where the pull plate comprises a pull plate front and two pull plate sides and where each pull plate side has an engagement hook on the lower edge, a knob on the inner face, and a pivot aperture on the rear part;
where the latch tong is largely cylindrical comprising;
a double groove on each flat side, the double groove further comprising a horizontal pass-through at the rear and lower part, a latch hole at the rear and upper part and a slideable slot with a stop hook on the lower edge comprising a connector hole;
a catch cavity on the top; and
a pull recess in the front end,
where the up-and-down piece fits in a catch cavity in the latch tong and comprises a catch nose which can be operably extended from the catch cavity.
